(19) United States
(12) Patent Application Publication
(10) Pub. No.: US 2007/0126188 A1
(43) Pub. Date: Jun. 7, 2007

(54) PTO CHUCK SPACER

(76) Inventors: Daniel Puzio, Baltimore, MD (US); Warren A. Ceroll, Owings Mills, MD (US)

Correspondence Address: HARNESS, DICKEY & PIERCE, P.L.C., P.O. BOX 8910, RESTON, VA, 20195, US

(21) Appl. No.: 11/539,455

(22) Filed: Oct. 6, 2006

Related U.S. Application Data
(60) Provisional application No. 60/724,987, filed on Oct. 11, 2005.

(51) Int. Cl. B23B 31/12

(52) U.S. Cl. 279/60; 279/157

(57) ABSTRACT

A tool chuck may include an input shaft. A chuck actuating shaft may be mounted for rotation on the input shaft. A chuck actuating screw may be coupled to the chuck actuating shaft. A spacer may be interposed between the chuck actuating shaft and the input shaft.

### CROSS REFERENCE TO RELATED APPLICATIONS

This US non-provisional application claims priority under 35 USC §119 to U.S. Provisional Application No. 60/724,987 filed Oct. 11, 2005, the content of which is incorporated herein in its entirety by reference.

### BACKGROUND

1. Field of the Invention

Example, non-limiting embodiments of the present invention relate in general to tool chucks for attachment of accessories to power drivers, and more particularly to a tool chuck having a spacer.

2. Description of Related Art

Tool chucks may be actuated (to open and close the chuck jaws) via a power take off (“PTO”) feature. Tool chucks with various PTO features are described in commonly-assigned, copending application Ser. No. 11/400,378 filed Apr. 10, 2006 (the “'378 application”). The entire contents of the '378 application are incorporated herein by reference.

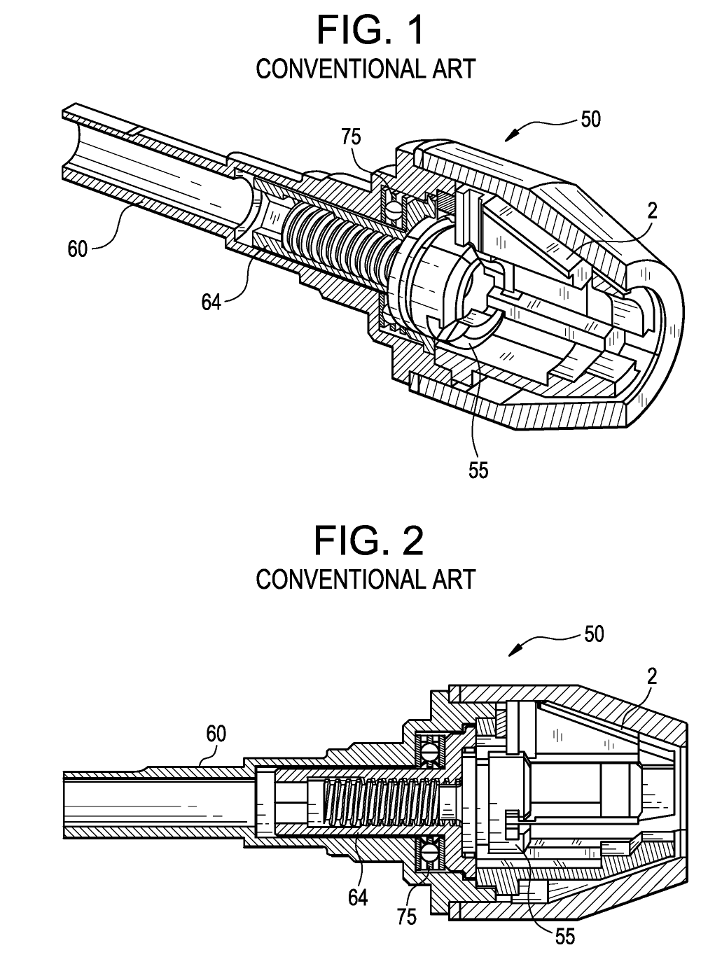

FIGS. 1 and 2 show a portion of a tool chuck 50 implementing a PTO feature. Those skilled in the art will recognize the chuck actuating screw 55, the input shaft 60 and the chuck actuating shaft 64, and understand how these component parts interact to actuate the chuck jaws 2.

A rolling element bearing 715 may be provided between the input shaft 60 and the chuck actuating shaft 64 to facilitate a relative rotation between these component parts. A relative rotation between the input shaft 60 and the chuck actuating shaft 64 may occur when the tool chuck 50 is operated in a MANUAL OVERRIDE MODE and/or a CHUCK MODE (for example), as described in the '378 application.

Although the rolling element bearing 75 is generally thought to provide acceptable performance, it is not without shortcomings. For example, axial thrust loads may be applied to the rolling element bearing 75 when the power driver provides a. hammer feature. Such axial thrust loads may cause high contact stresses to develop in the rolling elements (e.g., ball, pins, etc.) of the rolling element bearing 75. The axial thrust loads (rind the associated contact stresses) may shorten the life of the rolling element bearing 75.

### SUMMARY

According to an example, non-limiting embodiment, a tool chuck may include an input shaft. A chuck actuating shaft may be mounted for rotation on the input shaft. A chuck actuating screw may be coupled to the chuck actuating shaft. A spacer may be interposed between the chuck actuating shaft and the input shaft. No rolling elements may be interposed between the chuck actuating shaft and the input shaft.

According to another example, non-limiting embodiment, a tool chuck may include an input shaft. A chuck actuating shaft may be mounted for rotation on the input shaft. A chuck actuating screw may be coupled to the chuck actuating shaft. A spacer, without rolling elements, may be interposed between the chuck actuating shaft and the input shaft.

The above and other features, including various and novel details of construction and combinations of parts will be more particularly described with reference to the accompanying drawings. It will be understood that the details of the example embodiments are shown by way of illustration only and not as limitations of the invention. The principles and features of this invention may be employed in varied and numerous embodiments without departing from the scope of the invention.

### BRIEF DESCRIPTION OF THE DRWINGS

FIGS. 1 and 2 are schematic illustrations of a tool chuck implementing a conventional rolling element bearing.

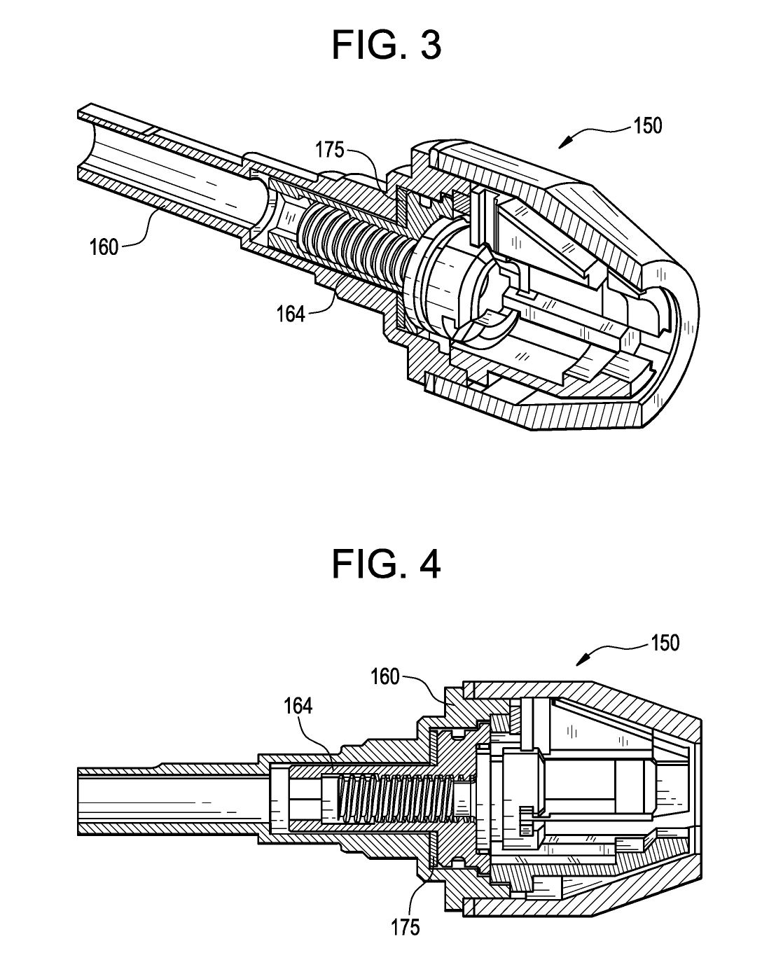

FIGS. 3 and 4 are schema tic illustrations of a tool chuck implementing a spacer in accordance with an example, non-limiting embodiment of the present invention.

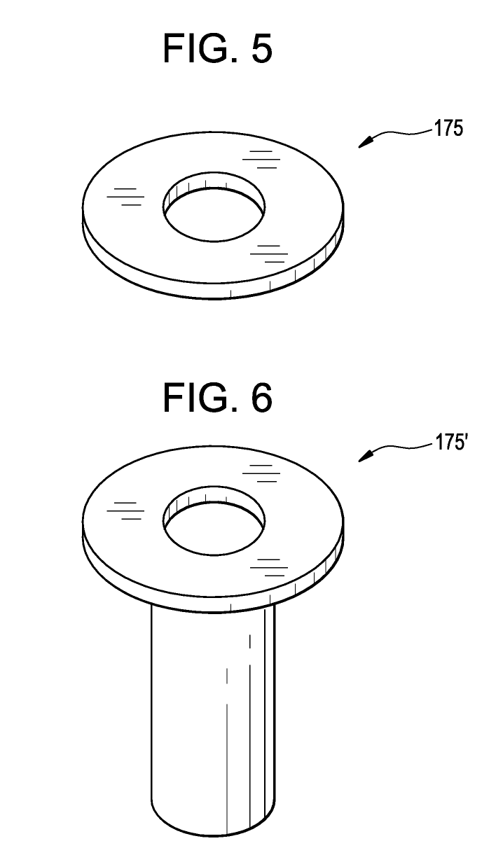

FIG. 5 is a perspective view of the spacer shown in FIGS. 3 and 4.

FIG. 6 is a perspective view of a spacer in accordance with another example, non-limiting embodiment of the present invention.

### DESCRIPTION OF EXAMPLE, NON-LIMITING EMBODIMENTS

The example tool chuck 150 depicted in FIGS. 3 and 4 is similar to the conventional tool chuck 50 shown in FIGS. 1 and 2. However, as shown in FIGS. 3 and 4, the example tool chuck 150 may include a spacer 175 (instead of the rolling element bearing 75) to facilitate a relative rotation between the input shaft 160 and the chuck actuating shaft 164.

The spacer 175 may not include any rolling elements. In this example embodiment, the spacer 175 may be a solid body having a washer shape, as shown in FIG. 5. In alternative embodiments, the spacer 175′ may be a solid body having a flanged sleeve shape, as shown in FIG. 6. It will be appreciated that the shape of the spacer may be suitably varied depending on the particular application.

By way of example only, the spacer 175 may be fabricated from numerous and varied polymer materials inclusive of (but not limited to) thermoplastic alloys, thermosetting alloys and/or polymer blends. Such materials may be selected based on characteristics such as compressive strength, coefficient of friction and/or wear characteristics. For example, a suitable polymer spacer 175 may have a compressive strength of greater than about 3,000 psi, a coefficient of static friction of less than about 0.3μ, and/or wear characteristics such that no appreciable dimensional changes (e.g., thinning) occur over the life cycle of the power driver. Polymer spacers sold under the IGLIDE® line by Igus Inc. have been suitably implemented.

In the example, non-limiting embodiment, the spacer 175 may be implemented for dry operation. Here, a solid lubricant may be distributed throughout the thickness of the spacer 175. The spacer 175 may have a solid body construction.

In alternative embodiments, the spacer 175 may be implemented for wet operation. Here, a liquid lubricant may be applied to the spacer 175. The spacer 175 may have voids for accommodating the liquid lubricant.

In alternative embodiments, the spacer 175 may have a laminated. structure. For example, the spacer 175 may include a more elastic inner layer, and harder outer layers having the desired compressive strength, coefficient of friction and/or wear characteristics. A laminated structure may be suitably implemented for wet and dry operations, as desired.

In alternative embodiments, the spacer 175 may be a liquid lubricant (or grease) disposed between the bearing surfaces of the input shaft 160 and the chuck actuating shaft 164. Here, the liquid lubricant may be contained between the bearing surfaces of the input shaft 160 and the chuck actuating shaft 164 without any “third party” element being interposed between the bearing surfaces of the input shaft 160 and the chuck actuating shaft 164 (such as a solid body or a body having voids, as in the previous embodiments). By way of example only, seals may be provided to contain the liquid lubricant as desired.

Although the example embodiment may implement a polymer spacer 175, it will be appreciated that spacers 175 may be fabricated from numerous a varied alternative materials (other than polymers).

What is claimed is:

1. A tool chuck comprising:
an input shaft;
a chuck actuating shaft mounted for rotation on the input shaft;
a chuck actuating screw coupled to the chuck actuating shaft; and
a spacer interposed between the chuck actuating shaft and the input shaft;
wherein no rolling elements are interposed between the chuck actuating shaft and the input shaft.

2. The tool chuck according to claim 1, wherein the spacer is a solid body.

3. The tool chuck according to claim 2, wherein the solid body includes a dry lubricant.

4. The tool chuck according to claim 1, wherein the spacer is a body having voids.

5. The tool chuck according to claim 3, wherein the voids accommodate a wet lubricant.

6. The tool chuck according to claim 1, wherein the spacer has opposed outer layers and an intervening inner layer.

7. The tool chuck according to claim 6, wherein the outer layers are harder than the intervening inner layer.

8. The tool chuck according to claim 1, wherein the spacer has a washer shape.

9. The tool chuck according to claim 1, wherein the spacer has a flanged sleeve shape.

10. The tool chuck according to claim 1, wherein the spacer is fabricated from a polymer material.

11. A tool chuck comprising:
an input shaft;
a chuck actuating shaft mounted for rotation on the input shaft;
a chuck actuating screw coupled to the chuck actuating shaft; and
a spacer, without rolling elements, interposed between the chuck actuating shaft and the input shaft.

12. The tool chuck according to claim 11, wherein the spacer is a solid body.

13. The tool chuck according to claim 12, wherein the solid body includes a dry lubricant.

14. The tool chuck according to claim 11, wherein the spacer is a body having voids.

15. The tool chuck according to claim 13, wherein the voids accommodate a wet lubricant.

16. The tool chuck according to claim 11, wherein the spacer has opposed outer layers and an intervening inner layer.

17. The tool chuck according to claim 16, wherein the outer layers are harder than the intervening inner layer.

18. The tool chuck according to claim 11, wherein the spacer has a washer shape.

19. The tool chuck according to claim 11, wherein the spacer has a flanged sleeve shape.

20. The tool chuck according to claim 11, wherein the spacer is fabricated from a polymer material.
